(19) United States
(12) Patent Application Publication
(10) Pub. No.: US 2005/0271142 A1
(43) Pub. Date: Dec. 8, 2005

(54) Method and apparatus for lossless encoding and decoding

(75) Inventors: Yung-Iyul Lee, Seoul (KR); Ki-hoon Han, Seoul (KR); Yung-ki Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignees: DAEYANG FOUNDATION; SAMSUNG ELECTRONICS CO., LTD.

(21) Appl. No.: 11/146,032

(22) Filed: Jun. 7, 2005

(30) Foreign Application Priority Data
Jun. 7, 2004 (KR) 10-2004-0041399
Jul. 26, 2004 (KR) 10-2004-0058349

(51) Int. Cl. H04N 7/12

(52) U.S. Cl. 375/240.12; 375/240.24; 375/240.23

(57) ABSTRACT

A lossless moving picture encoding and decoding method and apparatus are provided by which when intra prediction of a block with a predetermined size is performed, the compression ratio is increased by using a pixel in a block to be predicted. The lossless moving picture encoding method includes: predicting each of pixel values in an M×N block to be predicted by using a pixel in the M×N block closest to the object pixel value in a prediction direction determined by an encoding mode; and entropy coding a difference between the predicted pixel value and the pixel value to be predicted. According to this method, the compression ratio becomes much higher than that of a conventional lossless encoding method.

This application claims priority from Korean Patent Application Nos. 2004-41399 and 2004-58349 filed on Jun. 7, 2004 and Jul. 26, 2004, respectively, in the Korean Intellectual Property Office, the disclosures of which are incorporated herein in their entireties by reference.

### BACKGROUND OF THE INVENTION

1. Field of the Invention

Apparatuses and methods consistent with the present invention relate to encoding and decoding of moving picture data, and more particularly, to a lossless moving picture encoding and decoding by which when intra prediction is performed for a block of a predetermined size, by using a pixel in the block to be predicted, a compression ratio is increased.

2. Description of the Related Art

According to the H.264 standard set up for encoding and decoding moving picture data, a frame includes a plurality of macroblocks, and encoding and decoding are performed in units of macroblocks, or in units of sub blocks which are obtained by dividing a macroblock into two or four units. There are two methods of predicting the motion of a macroblock of a current frame to be encoded: temporal prediction which draws reference from macroblocks of an adjacent frame, and spatial prediction which draws reference from an adjacent macroblock.

Spatial prediction is also referred to as intra prediction. Intra prediction is based on the characteristic that when a pixel is predicted, an adjacent pixel is most likely to have a most similar value.

Meanwhile, encoding can be broken down into lossy encoding and lossless encoding. In order to perform lossless encoding of moving pictures, a predicted pixel value calculated by motion prediction is subtracted from a current pixel value. Then, without discrete cosine transform (DCT) or quantization, entropy coding is performed and the result is output. In the conventional method, when lossless encoding is performed, each pixel value in a block to be predicted is predicted by using a pixel value of a block adjacent to the block to be predicted, and therefore the compression ratio is much lower than that of lossy encoding.

### SUMMARY OF THE INVENTION

The present invention provides a lossless moving picture encoding and decoding method and apparatus by which when intra prediction of a block with a predetermined size is performed, the compression ratio is increased by using a pixel in a block to be predicted.

According to an aspect of the present invention, there is provided a lossless moving picture encoding method including: predicting each of pixel values in an M×N block to be predicted by using a pixel in the M×N block closest to the pixel value in a prediction direction determined by an encoding mode; and entropy coding a difference between the predicted pixel value and the pixel value to be predicted.

When the block to be predicted is a luminance block or a G block, the M×N block may be any one of a 4×4 block, an 8×8 block, and a 16×16 block, and when it is any one of a chrominance block, an R block, and a B block, the M×N block may be an 8×8 block.

For a luminance block or a G block, the encoding modes may be Vertical mode, Horizontal mode, DC mode, Diagonal_Down_Left, Diagonal_Down_Right, Vertical_Right, Horizontal_Down, Vertical_Left, and Horizontal_Up, which are H.264 intra 4×4 luminance encoding modes.

For any one of a chrominance block, an R block and a B block, the encoding modes may be Vertical mode, Horizontal mode, and DC mode, which are H.264 intra M×N chrominance encoding modes.

According to another aspect of the present invention, there is provided a lossless moving picture decoding method including: receiving a bitstream obtained by performing entropy coding based on prediction values, each predicted by using a closest pixel in a prediction direction determined according to an encoding mode, in an M×N block which is a prediction block unit; entropy decoding the bitstream; and losslessly restoring an original image according to the decoded values.

According to still another aspect of the present invention, there is provided a lossless moving picture encoding apparatus including: a motion prediction unit which predicts each of pixel values in an M×N block to be predicted by using a pixel in the M×N block closest to the pixel value in a prediction direction determined by an encoding mode; and an entropy coding unit which performs entropy coding on a difference between the predicted pixel value and the pixel value to be predicted.

According to still another aspect of the present invention, there is provided a lossless moving picture decoding apparatus including: an entropy decoding unit which receives a bitstream obtained by performing entropy coding based on values predicted by using a closest pixel in a prediction direction determined according to an encoding mode, in an M×N block which is a prediction block unit, and performs entropy decoding on the bitstream; and a moving picture restoration unit which losslessly restores an original image according to the decoded values.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an encoding apparatus according to an exemplary embodiment of the present invention;

FIG. 2 is a diagram showing intra prediction modes for a 4×4 block in H.264;

FIG. 3A illustrates pixel prediction of a luminance block and a G block in Vertical mode (mode 0);

FIG. 3B illustrates pixel prediction of a luminance block and a G block in Horizontal mode (mode 1);

FIG. 3C illustrates pixel prediction of a luminance block and a G block in Diagonal_Down_Left mode (mode 3);

FIG. 3D illustrates pixel prediction of a luminance block and a G block in Diagonal_Down_Right mode (mode 4);

FIG. 3E illustrates pixel prediction of a luminance block and a G block in Vertical_Right mode (mode 5);

FIG. 3F illustrates pixel prediction of a luminance block and a G block in Horizontal_Down mode (mode 6);

FIG. 3G illustrates pixel prediction of a luminance block and a G block in Vertical_Left mode (mode 7);

FIG. 3H illustrates pixel prediction of a luminance block and a G block in Horizontal_Up mode (mode 8);

FIG. 4A illustrates pixel prediction of a chrominance block, an R block, and a B block in DC mode;

FIG. 4B illustrates pixel prediction of a chrominance block, an R block, and a B block in Horizontal mode;

FIG. 4C illustrates pixel prediction of a chrominance block, an R block, and. a B block in Vertical mode;

FIG. 5 illustrates a prediction method when encoding and decoding are performed in the above modes; and

FIG. 6 is a block diagram of a decoding apparatus according to an exemplary embodiment of the present invention; and

FIG. 7 is a flowchart of an encoding method according to the present invention.

### DETAILED DESCRIPTION OF EXEMPLARY EMBODIMENTS OF THE INVENTION

In order to explain exemplary embodiments of the present invention, first, defining a prediction value and a residual value will now be explained.

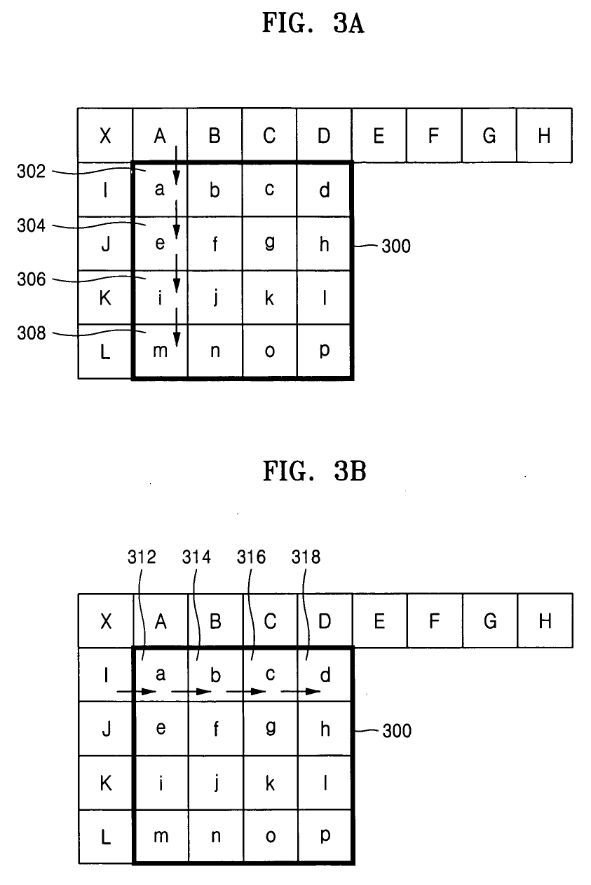

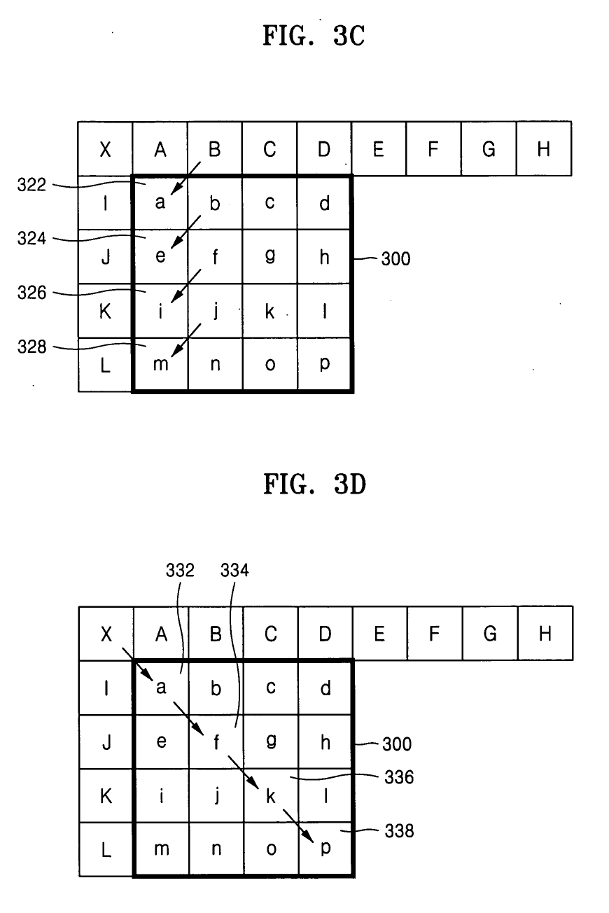

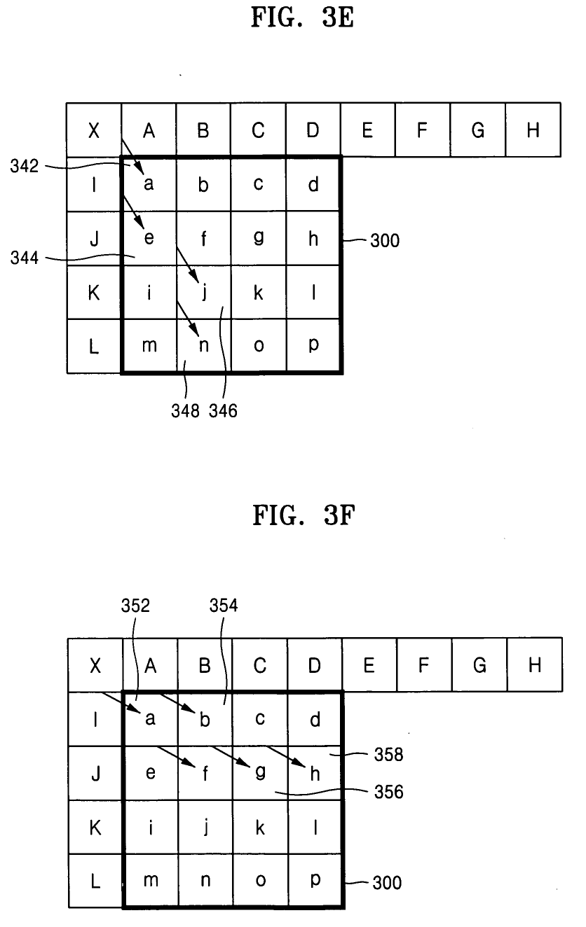

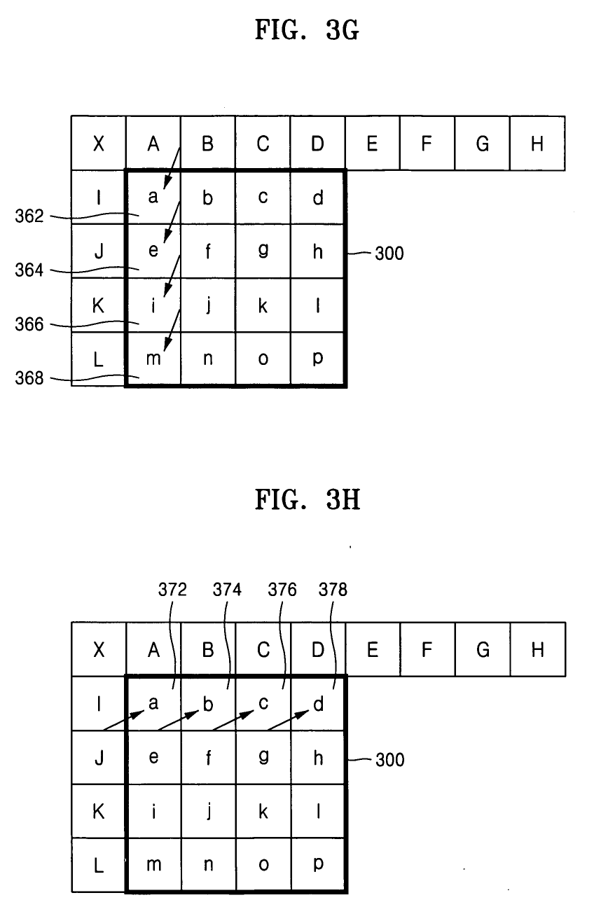

Assuming that the position of a pixel on the top left corner is x=0, y=0, p[x, y] indicates a pixel value on a relative position (x, y). For example, in FIG. 3A, the position of pixel a is expressed as [0, 0], the position of pixel b is as [1, 0], the position of pixel c is as [2, 0], the position of pixel d is as [3, 0], and the position of pixel e is as [0, 1]. The positions of the remaining pixels f through p can be expressed in the same manner.

A prediction value when a pixel is predicted by the original H.264 method without modifying the prediction method is expressed as pred_{L}[x, y]. For example, the prediction value of pixel a in FIG. 3A is expressed as pred_{L}[0, 0]. In the same manner, the prediction value of pixel b is pred_{L}[1, 0], the prediction value of pixel c is pred_{L}[2, 0], the prediction value of pixel d is pred_{L}[3, 0], and the prediction value of pixel e is pred_{L}[0, 1]. The prediction values of the remaining pixels f through p can be expressed in the same manner.

A prediction value when a pixel is predicted from adjacent pixels according to the present invention is expressed as pred_{L′}[x, y]. The position of a pixel is expressed in the same manner as in pred_{L}[x, y]. The residual value of position (i, j) obtained by subtracting the pixel prediction value at position (i, j) from the pixel value at position (i, j) is expressed as rᵢⱼ. The pixel value of position (i, j) restored by adding the pixel prediction value at position (i, j) and the residual value at position (i, j) when decoding is performed, is expressed as uᵢⱼ.

The present invention will now be described more fully with reference to the accompanying drawings, in which exemplary embodiments of the invention are shown.

Referring to FIG. I showing an encoding apparatus according to an exemplary embodiment of the present invention, if an image is input, motion prediction is performed. In the present invention, pixels of a luminance block and a G block are obtained by performing 4×4 intra prediction and pixels of a chrominance block, an R block, and a B block are obtained by performing 8×8 intra prediction. Accordingly, a motion prediction unit 110 performs 4×4 intra prediction for pixels of a luminance block and a G block in a macroblock to be predicted and 8×8 intra prediction for pixels of a chrominance block, an R block, and a B block. Calculation of predicted pixel values when 4×4 intra prediction and 8×8 intra prediction are performed will be explained later. A mode selection unit 120 selects one optimum mode among a variety of prediction modes. That is, when 4×4 intra prediction and 8×8 intra prediction are performed, one mode is selected from among a plurality of available encoding modes. Generally, one mode is selected according to a rate-distortion (RD) optimization method which minimizes rate-distortion. Since there is no distortion in the lossless encoding of the present invention, one encoding mode is determined through optimization of rates.

An entropy coding unit 130 entropy-codes a difference value output from the motion prediction unit 110, that is, the difference between a pixel value in a macroblock of a current frame desired to be encoded and a predicted pixel value, and outputs the result. Entropy coding means a coding method by which less bits are assigned to more frequent data and more bits are assigned to less frequent data such that the compression ratio of data is increased. The entropy coding methods used in the present invention include context adaptive variable length coding (CAVLC), and context-based adaptive binary arithmetic coding (CABAC).

FIG. 2 is a diagram showing intra prediction modes for a 4×4 block in H.264.

Intra prediction of pixels in a luminance block and a G block is performed in units of 4×4 blocks. There are nine types of 4×4 intra prediction modes corresponding to different prediction directions, including: Vertical mode (mode 0), Horizontal mode (mode 1), DC mode (mode 2), Diagonal_Down_Left (mode 3), Diagonal_Down_Right (mode 4), Vertical_Right (mode 5), Horizontal_Down (mode 6), Vertical_Left (mode 7), and Horizontal_Up (mode 8). The arrows in FIG. 2 indicate prediction directions. Calculation of a pixel in each mode will now be explained in more detail.

FIG. 3A illustrates pixel prediction of a luminance block and a G block in Vertical mode (mode 0).

Pixel a 302 is predicted from pixel A, which is an adjacent pixel in the vertical direction, and pixel e 304 is predicted not from pixel A adjacent to the block 300 to be predicted but from pixel a 302 which is adjacent to pixel e 304 in the block 300. Also, pixel i 306 is predicted from pixel e 304 and pixel m 308 is predicted from pixel i 306.

In the same manner, pixel b is predicted from pixel B, pixel f from pixel b, pixel j from pixel f, pixel n from pixel j, pixel c from pixel C, pixel g from pixel c, pixel k from pixel g, pixel o from pixel k, pixel d from pixel D, pixel h from pixel d, pixel l from pixel h, and pixel p from pixel l. Here, prediction means to output the difference (residual value) of pixel values and to entropy code the difference. That is, for pixels a, e, i, and m in the block 300 to be predicted, residual values (a−A), (e−a), (i−e), and (m−i), are output and entropy coded, respectively. The pixel prediction method in Vertical mode (mode 0) can be expressed as the following equation:
pred4×4_{L′}[x,y]=p[x,y−1], x,y=0, . . . , 3

FIG. 3B illustrates pixel prediction of a luminance block and a G block in Horizontal mode (mode 1).

Pixel a 312 is predicted from pixel I, which is an adjacent pixel in the horizontal direction, and pixel b 314 is predicted not from pixel I adjacent to the block 300 to be predicted but from pixel a 312 which is adjacent to pixel b 314 in the block 300. Also, pixel c 316 is predicted from pixel b 314 and pixel d 318 is predicted from pixel c 316.

In the same manner, pixel e is predicted from pixel J, pixel f from pixel e, pixel g from pixel f, pixel h from pixel g, pixel i from pixel K, pixel j from pixel i, pixel k from pixel j, pixel l from pixel k, pixel m from pixel L, pixel n from pixel m, pixel o from pixel n, and pixel p from pixel o. The pixel prediction method in Horizontal mode (mode_1) can be expressed as the following equation:
pred4×4_{L′}[x,y]=p[x−1,y], x,y=0, . . . , 3

FIG. 3C illustrates pixel prediction of a luminance block and a G block in Diagonal_Down_Left mode (mode 3).

Pixel a 322 is predicted from pixel B that is an adjacent pixel in the diagonal direction indicated by an arrow in FIG. 3C, and pixel e 324 is predicted from pixel b that is a pixel adjacent to pixel e 324 in the arrow direction in the block 300. Also, pixel i 326 is predicted from pixel f and pixel m 328 is predicted from pixel j.

In this manner, pixel b is predicted from pixel C, pixel c from pixel D, pixel d from pixel E, pixel f from pixel c, pixel g from pixel d, pixel h from pixel d, pixel j from pixel g, pixel k from pixel h, pixel l from pixel h, pixel n is from pixel k, pixel o from pixel l, and pixel p from pixel l. The pixel prediction method in Diagonal_Down_Left mode (mode 3) can be expressed as the following equation:
if x=3,y≠0,pred_{L′}[x,y]=p[x1,y−1], else, pred_{L′}[x,y]=p[x+1,y−1]

Also, when a pixel is predicted in Diagonal_Down_Left mode (mode 3), prediction can be performed by using an appropriate filter for pixels in prediction directions. For example, when 1:2:1 filter is used, pixel a 322 is predicted from (A+2B+C+2)/4 which is formed using pixel values located in the diagonal direction indicated by arrows in FIG. 3C, and pixel e 324 is predicted from (a+2b+c+2)/4 which is formed using pixel values located adjacent to pixel e 324 in the diagonal direction in the block 300. Also, pixel i 326 is predicted from (e+2f+g+2)/4 and pixel m 328 is predicted from (i+2j+k+2)/4.

In the same manner, pixel b is predicted from (B+2C+D+2), pixel c from (C+2D+E+2)/4, pixel d from (D+2E+F+2)/4, pixel f from (b+2c+d+2)/4, pixel g from (c+2d+d+2)/4, pixel h from (d+2d+d+2)/4, pixel j from (f+2g+h+2)/4, pixel k from (g+2h+h+2)/4, pixel l from (h+2h+h+2)/4, pixel n from (j+2k+l+2)/4, pixel o from (k+2l +l+2)/4, and pixel p from (l+2l +l+2)/4.

FIG. 3D illustrates pixel prediction of a luminance block and a G block in Diagonal_Down_Right mode (mode 4).

Pixel a 322 is predicted from pixel X that is an adjacent pixel in the diagonal direction indicated by an arrow in FIG. 3D, and pixel f 334 is predicted from pixel a that is a pixel adjacent to pixel f 334 in the arrow direction in the block 300. Also, pixel k 336 is predicted from pixel f and pixel p 338 is predicted from pixel k.

In this manner, pixel b predicted from pixel A, pixel c from pixel B, pixel d from pixel C, pixel e from pixel I, pixel g from pixel b, pixel h from pixel c, pixel i from pixel J, pixel j from pixel e, pixel l from pixel g, pixel is from pixel K, pixel n from pixel i, and pixel o from pixel j. The pixel prediction method in Diagonal_Down_Right mode (mode 4) can be expressed as the following equation:
pred4×4_{L′}[x,y]=p[x−1,y−1], x,y=0, . . . , 3

Also, when a pixel is predicted in Diagonal_Down_Right mode (mode 4), prediction can be performed by using an appropriate filter for pixels in prediction directions. For example, when 1:2:1 filter is used, pixel a 332 is predicted from (I+2X+A+2)/4 which is formed using pixel values located in the diagonal direction indicated by arrows in FIG. 3D, and pixel f 334 is predicted from (I+2a+b+2)/4 which is formed using pixel values located adjacent to pixel f 334 in the arrow direction in the block 300. Also, pixel k 336 is predicted from (e+2f+g+2)/4 and pixel p 338 is predicted from (j+2k+l+2)/4.

In the same manner, pixel b is predicted from (X+2A+B+2)/4, pixel c from (A+2B+C+2)/4, pixel d from (B+2C+D+2)/4, pixel e from (J+2I+a+2)/4, pixel g from (a+2b+c+2)/4, pixel h from (b+2c+d+2)/4, pixel i from (K+2J+e+2)/4, pixel j from (J+2e+f+2)/4, pixel l from (f+2g+h +2)/4, pixel m from (L+2K+i+2)/4, pixel n from (K+2i+j+2)/4, and pixel o from (i+2j+k+2)/4.

FIG. 3E illustrates pixel prediction of a luminance block and a G block in Vertical_Right mode (mode 5).

Pixel a 342 is predicted from (X+A+1)/2 which is formed using pixel values located in the diagonal direction at an angle of 22.5° from vertical, as indicated by arrows in FIG. 3E, and pixel e 344 is predicted from (I+a+1)/2 which is formed using pixel values located adjacent to pixel e 344 in the arrow direction at an angle of 22.5° from vertical, in the block 300. Also, pixel j 346 is predicted from (e+f+1)/2 and pixel n 348 is predicted from (i+j+1)/2.

In the same manner, pixel b is predicted from (A+B+1)/2, pixel c from (B+C+1)/2, pixel d from (C+D+1)/2, pixel f from (a+b+1)/2, pixel g from (b+c+1)/2, pixel h from (c+d+1)/2, pixel i from (J+e+1)/2, pixel k from (f+g+1)/2, pixel I from (g+h+1)/2, pixel m from (K+i+1)/2, pixel o from (j+k+1)/2, and pixel p from (k+l+1)/2. The pixel prediction method in Vertical_Right mode (mode 5) can be expressed as the following equations:
pred4×4_{L′}[0,0]=p[−1,−1]+p[0,−1]+1)>>1
pred4×4_{L′}[1,0]=p[0,−1]+p[1,−1]+1)>>1
pred4×4_{L′}[2,0]=p[1,−1]+p[2,1]+1)>>1
pred4×4_{L′}[3,0]=p[2,−1]+p[3,−1]+1)>>1
pred4×4_{L′}[0,1]=p[−1,0]+p[0,0]+1)>>1
pred4×4_{L′}[1,1]=p[0,0]+p[1,0]+1)>>1
pred4×4_{L′}[2,1]=p[1,0]+p[2,0]+1)>>1
pred4×4_{L′}[3,1]=p[2,0]+p[3,0]+1)>>1
pred4×4_{L′}[0,2]=p[−1,1]+p[0,1]+1)>>1
pred4×4_{L′}[1,2]=p[0,1]+p[1,1]+1)>>1
pred4×4_{L′}[2,2]=p[1,1]+p[2,1]+1)>>1
pred4×4_{L′}[3,2]=p[2,1]+p[3,1]+1)>>1
pred4×4_{L′}[0,3]=p[−1,2]+p[0,2]+1)>>1
pred4×4_{L′}[1,3]=p[0,2]+p[1,2]+1)>>1
pred4×4_{L′}[2,3]=p[1,2]+p[2,2]+1)>>1
pred4×4_{L′}[3,3]=p[2,2]+p[3,2]+1)>>1

FIG. 3F illustrates pixel prediction of a luminance block and a G block in Horizontal_Down mode (mode 6).

Pixel a 352 is predicted from (X+I+1)/2which is formed using pixel values located in the diagonal direction at an angle of 22.5° from horizontal, as indicated by arrows in FIG. 3F, and pixel b 354 is predicted from (A+a+1)/2which is formed using pixel values located adjacent to pixel b 354 in the arrow direction at an angle of 22.5° from horizontal, in the block 300. Also, pixel g 356 is predicted from (b+f+1)/2and pixel h 358 is predicted from (c+g+1)/2.

In the same manner, pixel i is predicted from (J+K+1)/2, pixel m from (K+L+1)/2, pixel f from (a+e+1)/2, pixel j from (e+i +1)/2, pixel n from (i+m+1)/2, pixel c from (B+b+1)/2, pixel k from (f+j+1)/2, pixel o from (j+n+1)/2, pixel d from (C+c+1)/2, pixel l from (g+k+1)/2, and pixel p from (k+o+1)/2. The pixel prediction method in Horizontal_Down mode (mode 6) can be expressed as the following equations:
pred4×4_{L′}[0,0]=p[−1,−1]+p[1—,0]+1)>>1
pred4×4_{L′}[0,1]=p[−1,0]+p[−1,1]+1)>>1
pred4×4_{L′}[0,2]=p[−1,1]+p[−1,2]+1)>>1
pred4×4_{L′}[0,3]=p[−1,2]+p[−1,3]+1)>>1
pred4×4_{L′}[1,0]=p[0,−1]+p[0,0]+1)>>1
pred4×4_{L′}[1,1]=p[0,0]+p[0,1]+1)>>1
pred4×4_{L′}[1,2]=p[0,1]+p[0,2]+1)>>1
pred4×4_{L′}[1,3]=p[0,2]+p[0,3]+1)>>1
pred4×4_{L′}[2,0]=p[1,−1]+p[1,0]+1)>>1
pred4×4_{L′}[2,1]=p[1,0]+p[1,1]+1)>>1
pred4×4_{L′}[2,2]=p[1,1]+p[1,2]+1)>>1
pred4×4_{L′}[2,3]=p[1,2]+p[1,3]+1)>>1
pred4×4_{L′}[3,0]=p[2,−1]+p[2,0]+1)>>1
pred4×4_{L′}[3,1]=p[2,0]+p[2,1]+1)>>1
pred4×4_{L′}[3,2]=p[2,1]+p[2,2]+1)>>1
pred4×4_{L′}[3,3]=p[2,2]+p[2,3]+1)>>1

FIG. 3G illustrates pixel prediction of a luminance block and a G block in Vertical_Left mode (mode 7).

Pixel a 362 is predicted from (A+B+1)/2which is formed using pixel values located in the diagonal direction at an angle of 22.5° from vertical, indicated by arrows in FIG. 3G, and pixel e 364 is predicted from (a+b+1)/2which is formed using pixel values located adjacent to pixel e 344 in the arrow direction at an angle of 22.5° from vertical, in the block 300. Also, pixel i 366 is predicted from (e+f+1)/2and pixel m 368 is predicted from (i+j+1)/2.

In the same manner, pixel b is predicted from (B+C+1)/2, pixel c from (C+D+1)/2, pixel d from (D+E+1)/2, pixel f from (b+c+1)/2, pixel g from (c+d+1)/2pixel h from d, pixel j from (f+g+1)/2, pixel k from (g+h+1)/2, pixel l from h, pixel n from (j+k+1)/2, pixel o from (k+l+1)/2, and pixel p from l. The pixel prediction method in Vertical_Left mode (mode 7) can be expressed as the following equations:
pred4×4_{L′}[0,0]=(p[0,−1]+p[1,−1]+1)>>1
pred4×4_{L′}[1,0]=(p[1,−1]+p[2,−1]+1)>>1
pred4×4_{L′}[2,0]=(p[2,−1]+p[3,−1]+1)>>1
pred4×4_{L′}[3,0]=(p[3,−1]+p[4,−1]+1)>>1
pred4×4_{L′}[0,1]=(p[0,0]+p[1,0]+1)>>1
pred4×4_{L′}[1,1]=(p[1,0]+p[2,0]+1)>>1
pred4×4_{L′}[2,1]=(p[2,0]+p[3,0]+1)>>1
pred4×4_{L′}[3,1]=p[3,0]
pred4×4_{L′}[0,2]=(p[0,1]+p[1,1]+1)>>1
pred4×4_{L′}[1,2]=(p[1,1]+p[2,1]+1)>>1
pred4×4_{L′}[2,2]=(p[2,1]+p[3,1]+1)>>1
pred4×4_{L′}[3,2]=p[3,1]
pred4×4_{L′}[0,3]=(p[0,2]+p[1,2]+1)>>1
pred4×4_{L′}[1,3]=(p[1,2]+p[2,2]+1)>>1
pred4×4_{L′}[2,3]=(p[2,2]+p[3,2]+1)>>1
pred4×4_{L′}[3,3]=p[3,2]

FIG. 3H illustrates pixel prediction of a luminance block and a G block in Horizontal_Up mode (mode 8).

Pixel a 372 is predicted from (I+J+1)/2which is formed using pixel values located in the diagonal direction at an angle of 22.5° from horizontal, as indicated by arrows in FIG. 3H, and pixel b 374 is predicted from (a+e+1)/2which is formed using pixel values located adjacent to pixel b 374 in the arrow direction at an angle of 22.5° from horizontal, in the block 300. Also, pixel c 376 is predicted from (b+f+1)/2and pixel d 378 is predicted from (c+g+1)/2.

In the same manner, pixel e is predicted from (J+K+1)/2, pixel I from (K+L+1)/2, pixel m from L, pixel f from (e+i+1)/2, pixel j from (i+m+1)/2, pixel n from m, pixel g from (f+j+1)/2, pixel k from (j+n+1)/2, pixel o from n, pixel h from (g+k+1)/2, pixel l from (k+o+1)/2, and pixel p from o. The pixel prediction method in Horizontal_Up mode (mode 8) can be expressed as the following equations:
pred4×4_{L′}[0,0]=(p[−1,0]+p[−1,1]+1)>>1
pred4×4_{L′}[0,1]=(p[−1,1]+p[−1,2]+1)>>1
pred4×4_{L′}[0,2]=(p[−1,2]+p[−1,3]+1)>>1
pred4×4_{L′}[0,3]=p[−1,3]
pred4×4_{L′}[1,0]=(p[0,0]+p[0,1]+1)>>1
pred4×4_{L′}[1,1]=(p[0,1]+p[0,2]+1)>>1
pred4×4_{L′}[1,2]=(p[0,2]+p[0,3]+1)>>1
pred4×4_{L′}[1,3]=p[0,3]
pred4×4_{L′}[2,0]=(p[1,0]+p[1,1]+1)>>1
pred4×4_{L′}[2,1]=(p[1,1]+p[1,2]+1)>>1
pred4×4_{L′}[2,2]=(p[1,2]+p[1,3]+1)>>1
pred4×4_{L′}[2,3]=p[1,3]
pred4×4_{L′}[3,0]=(p[2,0]+p[2,1]+1)>>1
pred4×4_{L′}[3,1]=(p[2,1]+p[2,2]+1)>>1
pred4×4_{L′}[3,2]=(p[2,2]+p[2,3]+1)>>1
pred4×4_{L′}[3,3]=p[2,3]

Finally, in DC mode (mode 2), all pixels in the block 300 to be predicted are predicted from (A+B+C+D+I+J+K+L+4)/8 which is formed using pixel values of blocks adjacent to the block 300.

So far, prediction of luminance block and G block pixels with a 4×4 block size has been described as examples. However, when the size of a luminance block is 8×8 or 16×16, the luminance pixel prediction method described above can also be applied in the same manner. For example, when the mode for an 8×8 block is Vertical mode, as described with reference to FIG. 3A, each pixel is predicted from a nearest adjacent pixel in the vertical direction. Accordingly, the only difference is that the size of the block is 8×8 or 16×16, and except that, the pixel prediction is the same as in Vertical mode for a 4×4 block.

Meanwhile, in addition to pixels formed with luminance and chrominance, for a red (R) block and a blue (B) block among R, green (G), and B blocks, the pixel prediction method for a chrominance pixel described below can be applied.

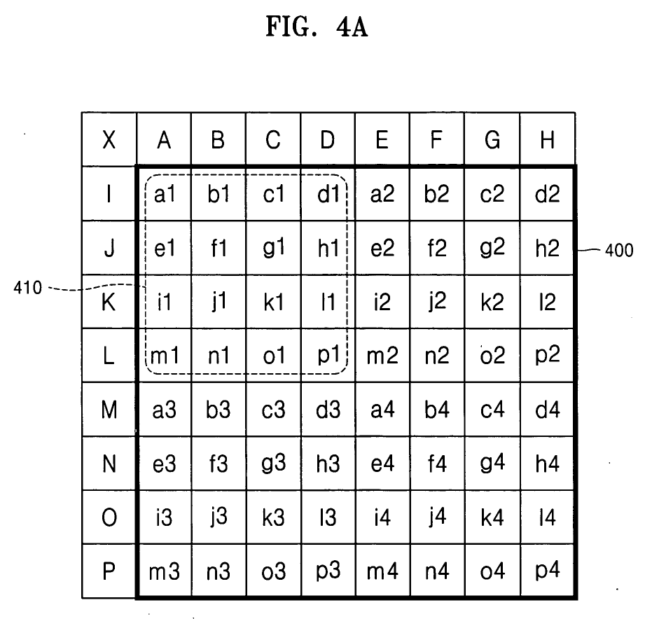

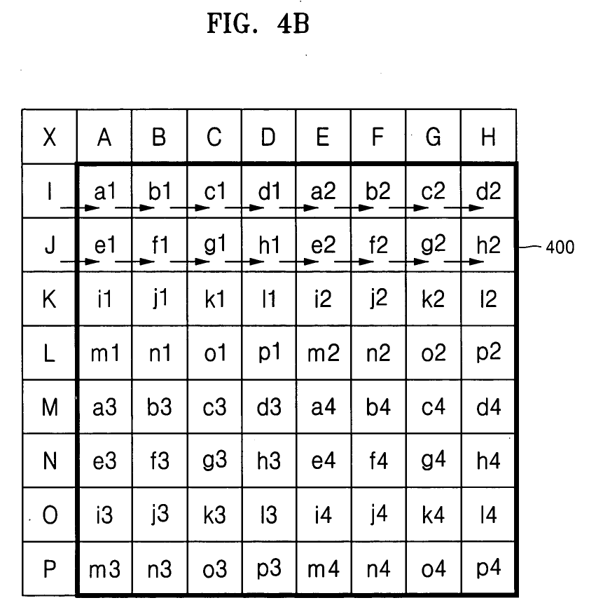

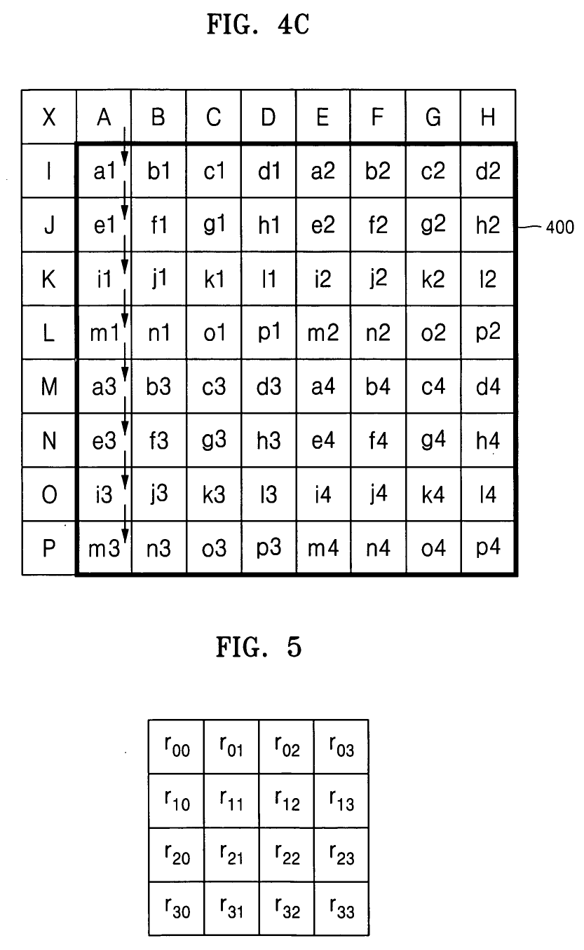

Next, calculation of pixels for a chrominance block, an R block, and B block will now be explained in detail with reference to FIGS. 4A through 4C.

Prediction of pixels of a chrominance block, an R block, and a B block is performed in units of 8×8 blocks, and there are 4 prediction modes, but in the present invention, plane mode is not used. Accordingly, in the present invention, only DC mode (mode 0), Horizontal mode (mode 1) and Vertical mode (mode 2) are used.

FIG. 4A illustrates pixel prediction of a chrominance block, an R block, and a B block in DC mode.

FIGS. 4A through 4C illustrate prediction for an 8×8 block, but the pixel prediction can be applied to an M×N block in the same manner when prediction of pixels in a chrominance block, an R block, and a B block is performed.

Referring to FIG. 4A, a1, b1, c1, d1, e1, f1, g1, h1, i1, j1, k1, l1, m1, n1, o1, and p1 which are all pixels in a 4×4 block 410 of an 8×8 block 400 are predicted from (A+B+C+D+I+J+K+L+4)/8. Also, pixels a2, b2, c2, d2, e2, f2, g2, h2, i2, j2, k2, l2, m2, n2, o2, and p2 are predicted from (E+F+G+H+2)/4 . Also, pixels a3, b3, c3, d3, e3, f3, g3, h3, i3, j3, k3, l3, m3, n3, o3, and p3 are predicted from (M+N+O+P+2)/4 and pixels a4, b4, c4, d4, e4, f4, g4, h4, i4, j4, k4, l4, m4, n4, o4, and p4 are predicted from (E+F+G+H+M+N+O+P+4)/8.

FIG. 4B illustrates pixel prediction of a chrominance block, an R block, and a B block in Horizontal mode.

Pixel a1 is predicted from pixel I, pixel b1 from pixel a1, and pixel c1 from pixel b1. Thus, prediction is performed by using an adjacent pixel in the horizontal direction in the block 400 to be predicted.

FIG. 4C illustrates pixel prediction of a chrominance block, an R block, and a B block in Vertical mode.

Pixel a1 is predicted from pixel A, pixel e1 from pixel a1, and pixel i1 from pixel e1. Thus, prediction is performed by using an adjacent pixel in the vertical direction in the block 400 to be predicted.

It is described above that pixel prediction is performed by using adjacent pixels in each of 4×4 block units in luminance block and G block prediction and is performed by using adjacent pixels in each of 8×8 block units in chrominance block, R block, and B block prediction. However, the prediction method is not limited to the 4×4 block or 8×8 block, and can be equally applied to blocks of an arbitrary size M×N. That is, even when a block unit to be predicted is an M×N block, a pixel value to be predicted can be calculated by using a pixel closest to the pixel value in a prediction direction in the block.

FIG. 5 illustrates a prediction method when encoding and decoding are performed in the above modes.

Referring to FIG. 5, another method for obtaining a residual by pixel prediction will now be explained. In the conventional encoder, in order to obtain a residual value, a pixel in an adjacent block is used. For example, in Vertical_mode of FIG. 3A, in the conventional method, pixels a 302, e 304, i 306, and m 308 are predicted all from pixel A, and therefore, residual values are r₀=a−A, r₁=e−A, r₂=i−A, and r₃=m−A. In the present invention, by using thus obtained conventional residual values, new residual values are calculated. Then, the new residual values are r′₀r₀, r′₁=r₁−r₀, r′₂=r₂−r₁, and r′₃=r₃−r₂. At this time, since the new residual values r′₀, r′₁, r′₂, and r′_{3 are r′}₀=a−A, r′₁=e−a, r′₂=i−e, and r′₃=m−i, r′₀, r′₁, r′₂, and r′₃ have the same values as the residual values predicted from the nearest adjacent pixels according to the prediction method described above. Accordingly, with the new residual values r′₀, r′₁, r′₂, and r′₃, in each mode as described above, the pixel prediction method using an adjacent pixel can be applied.

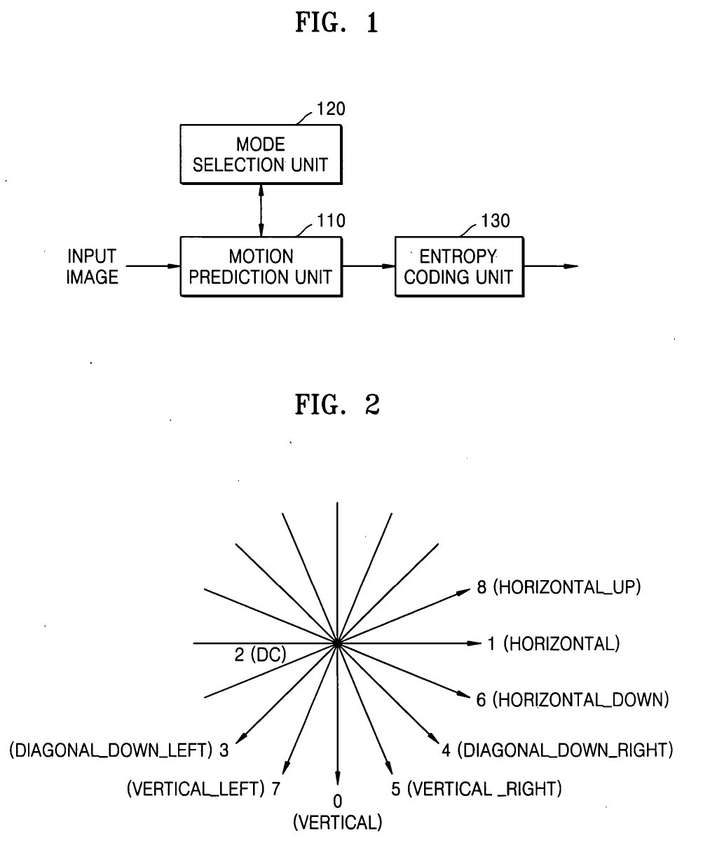

Accordingly, the motion prediction unit 110 of the encoding apparatus of the present invention of FIG. 1 can further include a residual value calculation unit generating new pixel values r′₀, r′₁, r′₂, and r′₃ from residuals.

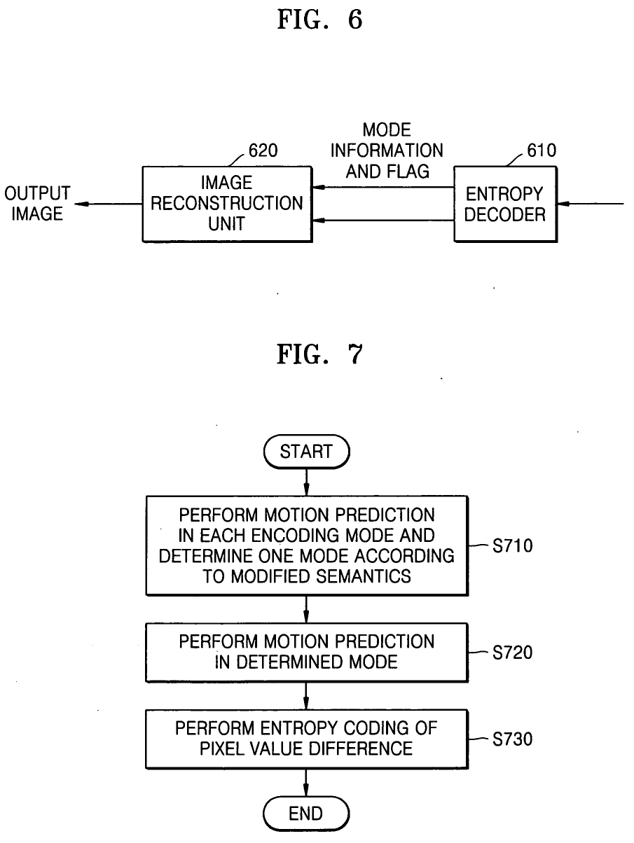

FIG. 6 is a block diagram of a decoding apparatus according to an exemplary embodiment of the present invention.

An entropy decoder 610 receives a bitstream encoded according to the present invention, and performs decoding according to an entropy decoding method such as CAVLC or CABAC. In the frontmost part of the received bitstream, a flag indicating that pixel values are predicted according to the present invention can be set. As an example of this flag, there is a lossless_qpprime_y_zero_flag in H.264.

By using this flag, information that pixel values are predicted according to the present invention is transferred to a moving picture reconstruction unit 620.

According to this flag information and encoding mode information, the moving picture reconstruction unit 620 restores moving pictures according to the pixel prediction calculation method in a mode of the present invention, and outputs the result.

FIG. 7 is a flowchart of an encoding method according to the present invention.

As described above, motion prediction is performed in a variety of intra prediction modes provided according to modified prediction methods, and an optimum mode is determined in operation S710. Also, without using the modified prediction methods, a block is formed by using residual values newly generated from residuals obtained by the conventional prediction method, and then, motion prediction under the intra prediction encoding mode can be performed. The optimum mode can be performed by RD optimization, and because lossless is encoding is used in the present invention, one encoding mode is determined by rate optimization. In the determined encoding mode, motion prediction is performed in operation S720. Then, the resulting value is entropy coded and output in operation S730.

Decoding is performed in the reverse of the order of the encoding. That is, the entropy coded bitstream is input, and entropy decoded. Then, based on encoding mode information and flag information, pixel values are restored according to the pixel prediction value calculation method of the present invention, and moving pictures are output.

At this time, the pixel values restored can be expressed as the following equations:

(1) If, when encoding is performed, the modified prediction method as described above is used and the encoding mode is determined as Vertical mode, pixel values are restored according to the following equation:

$$\begin{matrix}{u}_{ij} = {pred}_{L} [ {x}_{O + j} , {y}_{O + i} ] + {\sum }_{k = 0}^{i} {r}_{i - k , j} & i , j = 0 , … , 3 or \\ {u}_{ij} = {pred}_{{L}^{′}} [ {x}_{O + j} , {y}_{O} ] + {\sum }_{k = 0}^{i} {r}_{i - k , j} & i , j = 0 , … , 3\end{matrix}$$

(2) If, when encoding is performed, the modified prediction method as described above is used and the encoding mode is determined as Horizontal mode, pixel values are restored according to the following equation:

$$\begin{matrix}{u}_{ij} = {pred}_{L} [ {x}_{O + j} , {y}_{O + i} ] + {\sum }_{k = 0}^{j} {r}_{i , j - k} & i , j = 0 , … , 3 or \\ {u}_{ij} = {pred}_{{L}^{′}} [ {x}_{O} , {y}_{O + i} ] + {\sum }_{k = 0}^{j} {r}_{i , j - k} & i , j = 0 , … , 3\end{matrix}$$

(3) If, when encoding is performed, the modified prediction method as described above is used and the encoding mode is determined as Diagonal_Down_Left mode, pixel values are restored according to the following equation:
If i=0((i,j)=(0,0),(0,1),(0,2),(0,3)), uᵢⱼ=pred_{L′}[x_{O+j}, y_{O+i}]+rᵢⱼ, if i=1,j<3((i,j)=(1,0),(1,1),(1,2)), uᵢⱼ=pred_{L′}[x_{O+j+1},y_{O+i-1}]+rᵢ₋₁ⱼ₊₁+rᵢⱼ, if i=1,j=3(i,j)=(1,3)), uᵢⱼ=pred_{L′}[x_{O+j},y_{O+i-1}]+rᵢ₋₁ⱼ+rᵢⱼ, if i=2,j<2((i,j)=(2,0), (2,1)), uᵢⱼ=pred_{L′}[x_{O+j+2},y_{O+i-2}]+rᵢ₋₂ⱼ₊₂+rᵢ₋₁ⱼ₊₁+rᵢⱼ, if i=2,j=2((ij)=(2,2)), uᵢⱼ=pred_{L′}[x_{O+j+1},y_{O+i-2}]+rᵢ₋₂ⱼ₊₁+rᵢ₋₁ⱼ₋₁+rᵢⱼ, if i=2,j=3((i,j)=(2,3)), uᵢⱼ=pred_{L′}[x_{O+j},y_{O+i-2}]+rᵢ₋₂ⱼ+rᵢ₋₁ⱼrᵢⱼ, if i=3,j=0((i,j)=(3,0)), uᵢⱼ=pred_{L′}[x_{O+j+3},y_{O+i-3}]+rᵢ₋₃ⱼ₊₃+rᵢ₋₂ⱼ₊₂+rᵢ₋₁ⱼ₊₁rᵢⱼ, if i=3,j=1((i,j)=(3,1)), uᵢⱼ=pred_{L′}[x_{O+j+2},y_{O+i-3}]+rᵢ₋₃ⱼ₊₂+rᵢ₋₂ⱼ₊₂+rᵢ₋₁ⱼ₊₁rᵢⱼ, if i=3j=2((i,j)=(3,2)) uᵢⱼ=pred_{L′}[x_{O+j+1},y_{O+i-3}]+rᵢ₋₃ⱼ₊₁+rᵢ₋₂ⱼ₊₁+rᵢ₋₁ⱼ₊₁rᵢⱼ, if i=3,j=3((i,j)=(3,3)), uᵢⱼ=pred_{L′}[x_{O+j},y_{O+i-3}]+rᵢ₋₃ⱼ+rᵢ₋₂ⱼ+rᵢ₋₁ⱼrᵢⱼ.

(4) If, when encoding is performed, the modified prediction method as described above is used and the encoding mode is determined as Diagonal_Down_Right mode, pixel values are restored according to the following equation:
If i=0,or j=0((i,j)=(0,0), (0,1), (0,2), (0,3), (1,0), (2,0), (3,0)), uᵢⱼ=pred_{L′}[x_{O+j},y_{O+i}]+rᵢⱼ, if i=1, j>=1,or j=1, i>1((i,j)=(1,1), (1,2), (1,3), (2,1), (3,1)), uᵢⱼ=pred_{L′}[x_{O+j},y_{O+i}]+rᵢ₋₁ⱼ₋₁+rᵢⱼ, if i=2, j>=2,or j=2, i>2((i,j)=(2,2), (2,3), (3,2)), uᵢⱼ=pred_{L′}[x_{O+j},y_{O+i}]rᵢ₋₂ⱼ₌₂rᵢ₋₁ⱼ₋₁+rᵢⱼ, if i=j=3((i,j)=(3,3)), uᵢⱼ=pred_{L′}[x_{O+j},y_{O+i}]+rᵢ₋₃ⱼ₋₃rᵢ₋₂ⱼ₋₂+rᵢ₋₁ⱼ₋₁+rᵢⱼ.

(5) In the remaining modes, pixel values are restored by the following equation:

uᵢⱼ=pred_{L′}[x_{O+j},y_{O+i}]+rᵢⱼ

As the result of experiments performed according to the method described above, for various test images suggested by Joint Model 73 (JM73), which is an H.264 standardization group, the following compression efficiency improvement has been achieved. Experiment conditions are shown in Table 1 as follows:

TABLE 1

| | News | Container | Foreman | Silent | Paris | Mobile | Tempete |
|---|---|---|---|---|---|---|---|
| | (QCIF) | (QCIF) | (QCIF) | (QCIF) | (CIF) | (CIF) | (CIF) |
| Entire frame | 100 | 100 | 100 | 150 | 150 | 300 | 260 |
| | (10 Hz) | (10 Hz) | (10 Hz) | (15 Hz) | (15 Hz) | (30 Hz) | (30 Hz) |

| | |
|---|---|
| Condition | Rate Optimization, CABAC or CAVLC, Intra 4 × 4 Mode |

For all seven test images, moving pictures of 10 Hz, 15 Hz, and 30 Hz were experimented in various ways with 100 frames to 300 frames. Compression ratios when test images were compressed by the conventional compression method and by the compression method of the present invention (PI), respectively, under the experiment conditions as shown in table 1 are compared in Table 2 as follows:

TABLE 2

| | | | CABAC | | | CAVLC | | |
|---|---|---|---|---|---|---|---|---|
| | Original | | Total | | Relative | Total | | Relative |
| Image | Size (Bits) | Method | Bits | Compression | Bits (%) | Bits | Compression | Bits (%) |
| News | 91238400 | JM73 | 49062832 | 1.8596 | 100 | 52730184 | 1.7303 | 100 |
| (300 Frames) | | PI | 41909016 | 2.1771 | 85.4191 | 45048912 | 2.0253 | 85.4329 |
| Container | 91238400 | JM73 | 47836576 | 1.9073 | 100.0000 | 51976808 | 1.7554 | 100 |
| (300 Frames) | | PI | 42214496 | 2.1613 | 88.2473 | 45796656 | 1.9923 | 88.1098 |
| Foreman | 91238400 | JM73 | 50418312 | 1.8096 | 100 | 54997344 | 1.6590 | 100.0000 |
| (300 Frames) | | PI | 45126584 | 2.0218 | 89.5044 | 48981272 | 1.8627 | 89.0612 |
| Silent | 91238400 | JM73 | 54273064 | 1.6811 | 100 | 59704832 | 1.5282 | 100 |
| (300 Frames) | | PI | 47761392 | 1.9103 | 88.0020 | 51595640 | 1.7683 | 86.4179 |
| Paris | 364953600 | JM73 | 224766912 | 1.6237 | 100 | 243763312 | 1.4972 | 100 |
| (300 Frames) | | PI | 194010352 | 1.8811 | 86.3162 | 209244560 | 1.7441 | 85.8392 |
| Mobile | 364953600 | JM73 | 285423632 | 1.2786 | 100 | 310319680 | 1.1761 | 100 |
| (300 Frames) | | PI | 257143688 | 1.4193 | 90.0919 | 276517280 | 1.3198 | 89.1072 |
| Tempete | 316293120 | JM73 | 205817192 | 1.5368 | 100 | 225291464 | 1.4039 | 100 |
| (260 Frames) | | PI | 183106968 | 1.7274 | 88.9658 | 198472424 | 1.5936 | 88.0959 |
| Average | | JM73 | 131085503 | 1.6710 | 100 | 142683375 | 1.5357 | 100 |
| | | PI | 115896071 | 1.8997 | 88.0781 | 125093821 | 1.7580 | 87.4377 |

Meanwhile, Table 2 shows results when test images were generated as intra frames, by using only intra prediction, and, it can be seen that the compression ratio when only intra prediction was used is higher.

Meanwhile, the moving picture encoding and decoding method described above can be implemented as a computer program. The codes and code segments forming the program can be easily inferred by computer programmers in the field of the present invention. Also, the program can be stored in a computer readable medium and read and executed by a computer such that the moving picture encoding and decoding method is performed. The information storage medium may be a magnetic recording medium, an optical recording medium, or carrier waves.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the forgoing detailed description but by the appended claims, and all differences within the scope will be construed as being included in the present invention.

According to the present invention as described above, the compression ratio can be improved when lossless encoding is performed. In particular, when only intra prediction mode is used, the compression ratio is much higher than in the conventional method.

1. A lossless moving picture encoding method comprising:
predicting each of a plurality of pixel values in an M×N block to be predicted by using a pixel in the M×N block closest to a pixel value in a prediction direction determined by an encoding mode; and
entropy coding a difference between a predicted pixel value and a pixel value to be predicted.

2. The method of claim 1, wherein if the M×N block to be predicted is a luminance block or a G block, M×N is any one of 4×4, 8×8, and 16×16, and if the M×N block is one of a chrominance block, an R block, and a B block, M×N is 8×8.

3. The method of claim 1, wherein for a luminance block or a G block, the encoding mode is one of Vertical mode, Horizontal mode, DC mode, Diagonal_Down_Left, Diagonal_Down_Right, Vertical_Right, Horizontal_Down, Vertical_Left, and Horizontal_Up, which are H.264 intra 4×4 luminance encoding modes.

4. The method of claim 1, wherein for one of a chrominance block, an R block, and a B block, the encoding mode is one of Vertical mode, Horizontal mode, and DC mode, which are H.264 intra 8×8 chrominance encoding modes.

5. The method of claim 1, wherein the entropy coding the difference between the predicted pixel value and the pixel value to be predicted comprises:
determining an encoding mode having a lowest rate by performing intra prediction for predicting the pixel value for the M×N block in an H.264 intra encoding mode; and
entropy coding the difference between the predicted pixel value predicted according to the determined encoding mode and the pixel value to be predicted.

6. A lossless moving picture encoding method comprising:
when each of a plurality of pixels in an M×N block to be predicted is predicted, predicting a value of a pixel by obtaining a residual value with a pixel adjacent to the M×N block in a direction determined according to an encoding mode, and then, by using a nearest adjacent pixel in an M×N block formed by residuals; and
entropy coding a difference between a predicted pixel value and a pixel value to be predicted.

7. A lossless moving picture decoding method comprising:
receiving a bitstream obtained by performing entropy coding based on a plurality of prediction values, wherein each pixel is predicted by using a closest pixel in a prediction direction determined according to an encoding mode, in an M×N block which is a prediction block unit;
entropy decoding the bitstream; and
losslessly restoring an original image according to decoded values.

8. The method of claim 7, wherein if the M×N block is a luminance block or a G block, the M×N block is one of a 4×4 block, an 8×8 block, and a 16×16 block, and if the M×N block is one of a chrominance block, an R block, and a B block, the M×N block is an 8×8 block.

9. The method of claim 7, wherein for a luminance block or a G block, the encoding is one of Vertical mode, Horizontal mode, DC mode, Diagonal_Down_Left, Diagonal_Down_Right, Vertical_Right, Horizontal_Down, Vertical_Left, and Horizontal_Up, which are H.264 intra 4×4 luminance encoding modes.

10. The method of claim 7, wherein for one of a chrominance block, an R block, and a B block, the encoding mode is one of Vertical mode, Horizontal mode, and DC mode, which are H.264 intra M×N chrominance encoding modes.

11. A lossless moving picture encoding apparatus comprising:
a motion prediction unit which predicts each of a plurality of pixel values in an M×N block to be predicted by using a pixel in the M×N block closest to a pixel value in a prediction direction determined by an encoding mode; and
an entropy coding unit which performs entropy coding of a difference between a predicted pixel value and a pixel value to be predicted.

12. The apparatus of claim 11, wherein the motion prediction unit further comprises:
a residual value calculation unit which obtains a residual value by using a pixel adjacent to the M×N block to be predicted in the prediction direction determined according to the encoding mode, when each of the pixels in the M×N block is predicted, in order to predict the pixel value.

13. The apparatus of claim 11, wherein if the M×N block to be predicted is a luminance block or a G block, the M×N block is one of a 4×4 block, an 8×8 block, and a 16×16 block, and if the M×N block is one of a chrominance block, an R block, and a B block, the M×N block is an 8×8 block.

14. A lossless moving picture decoding apparatus comprising:
an entropy decoding unit which receives a bitstream obtained by performing entropy coding based on values predicted by using a closest pixel in a prediction direction determined according to an encoding mode, in an M×N block which is a prediction block unit, and performs entropy decoding on the bitstream; and
a moving picture restoration unit which losslessly restores an original image according to decoded values.

15. The apparatus of claim 14, wherein if the M×N block to be predicted is a luminance block or a G block, the M×N block is one of a 4×4 block, an 8×8 block, and a 16×16 block, and if the M×N block is one of a chrominance block, an R block, and a B block, the M×N block is an 8×8 block.
